(19) United States
(12) Patent Application Publication
(10) Pub. No.: US 2005/0097153 A1
(43) Pub. Date: May 5, 2005

(54) Pseudorandom number generator

(75) Inventors: Gerd Dirscherl, Munich (DE); Berndt Gammel, Markt Schwaben (DE); Rainer Gottfert, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/925,903

(22) Filed: Aug. 23, 2004

(30) Foreign Application Priority Data
Aug. 29, 2003 (DE) 103 39 999.2

(51) Int. Cl. G06F 1/02

(52) U.S. Cl. 708/250

(57) ABSTRACT

A pseudorandom number generator includes a first elemental shift register having a non-linear feedback feature, a second elemental shift register and combiner for combining signals at an output of the first elemental shift register and the second elemental shift register to obtain a combined signal representing a pseudorandom number. The combination of individual non-linear elemental shift registers allows a safe and flexible implementation of random number generators, the output sequences of which include a high linear complexity and a high period length.

### CROSS-REFERENCE TO RELATED APPLICATION

This application claims priority from German Patent Application No. 103 39 999.2, which was filed on Aug. 29, 2003, and is incorporated herein by reference in its entirety.

### BACKGROUND OF THE INVENTION

1. Field of the Invention

The present invention relates to pseudorandom number generators and, in particular, to pseudorandom number generators which are based on feedback shift registers.

2. Description of the Related Art

Such a well-known random number generator is illustrated in FIG. 12. The pseudorandom number generator of FIG. 12 which is also referred to as a linear feedback shift register, includes a plurality of memory elements 51, 52, 53, 54, which, in FIG. 12, are numbered 0 to n. The memory cells can be initialized to an initial value via initializing means 55. The memory cells 51 to 54 together form feedforward means, while the linear shift register formed by the memory cells 51 to 54, is fed back by feedback means coupled between an output 56 of the circuit and the memory cell n. In particular, the feedback means includes one or several combining means 57, 58 which are fed by respective feedback branches 59a, 59b, 59c as is exemplarily illustrated in FIG. 12. The initial value of the last combining means 58 is fed into the memory cell n which, in FIG. 12, is designated by 54.

The linear feedback shift register shown in FIG. 12 is driven by a clock so that the occupancy of the memory cells is shifted by one step, referring to FIG. 12, to the left in each clock cycle, so that in each clock cycle the state stored in the memory means 51 is output as a number, while at the same time the value is fed into the first memory unit n of the sequence of memory units at the output of the last combining means 58. The linear feedback shift register illustrated in FIG. 12 thus provides a sequence of numbers responsive to a sequence of clock cycles. The sequence of numbers obtained at the output 56 depends on the initial state made by the initializing means 55 before operating the shift register. The initial value input by the initializing means 55 is also referred to as a seed, which is why such arrangements illustrated in FIG. 12 are also referred to as seed generators.

The sequence of numbers obtained at the output 56 is referred to as a pseudorandom sequence of numbers since the numbers seem to follow one another in a seemingly random way, but are periodical in all even though the period duration is great. In addition, the sequence of numbers can be repeated unambiguously and thus has a pseudorandom character when the initializing value fed to the memory elements by the initializing means 55 is known. Such shift registers are, for example, employed as key stream generators to provide a stream of encoding/decoding keys depending on a special initializing value (seed).

Such shift registers illustrated in FIG. 12 have the disadvantage of a small linear complexity. Thus, 2 n bits of the output sequence are sufficient in an n-bit LFSR (LFSR=linear feedback shift register) to calculate the entire sequence. The advantage of such well-known LFSRs illustrated in FIG. 12, however, is that they incur very low hardware costs.

In addition, there are irregularly clocked LFSRs. They incur somewhat increased hardware costs with a mostly smaller period. The linear complexity, however, may be increased considerably. A disadvantage of such irregularly clocked devices, however, is the fact that the output sequence can, in principle, be established by means of measuring the current in an SPA (SPA=simple power analysis) due to the irregular clocking. By using the shift register devices as parts of key generators which produce data to be kept secret inherently, that is key data, it is of crucial importance for them to be safe against any kind of cryptographic attacks.

On the other hand, there is the requirement in such devices, in particular when they are to be accommodated on chip cards, that the hardware costs be low. Put differently, the chip area such devices occupy must be as small as possible. The reason for this is that in semiconductor manufacturing, the chip area of an entire device in the end determines the price and thus the profit margin of the chip manufacturer. In addition, a specification, especially in chip cards, usually is such that a customer sets the maximal area of a processor chip, in square millimeters, on which different functionalities must be accommodated. It is thus the task of the circuit manufacturer to distribute this valuable area for the individual components. As regards cryptographic algorithms which are becoming more complex all the time, efforts of the chip manufacturer are directed to the chip having the largest amount of memory possible to be able to calculate even algorithms requiring lots of working memory in an acceptable time. The chip area for key generators and other such components thus must be kept as small as possible in order to be able to accommodate a greater amount of memory on the chip area given.

The general requirement for key generators or devices for generating a pseudorandom sequence of numbers thus is to be safe on the one hand and to require as little space as possible on the other hand, that is to incur the lowest possible hardware costs.

In principle, linear shift registers have different applications in coding theory, cryptography and other areas in electro-technology. The output sequences of linear shift registers have useful structural features which can be divided into algebraic features and distribution features.

One knows that the output sequence of an n-step linear shift register, as has been explained, is periodic. The length of the period can be rather large and is often exponential as regards n, that is the number of memory elements. In particular, the length of the period is 2ⁿ−1 when the shift register is based on a primitive feedback polynomial.

The linear complexity of such a sequence, however, at most equals n. The linear complexity of a periodic sequence, as per definition, equals the number of cells of the smallest possible shift register the sequence considered can produce.

Due to this fact, it can be shown that, as has been explained, 2 n successive expressions of the sequence are sufficient to predict all the remaining expressions of the sequence. Additionally, there is an efficient algorithm, the so-called Berlekamp Massey algorithm, for calculating the parameters required to obtain the entire sequence. For this reason, sequences of linear shift registers, despite their potentially great periods and their statistically good distribution features, are not directly suitable as key sequences in so-called stream ciphers. In addition, there are other applications in which the comparatively small linear complexity of a sequence produced by a linear shift register is to be seen as a disadvantage.

Conventionally, linear shift registers are described by their characteristic polynomial. The degree of the characteristic polynomial equals the number of delay elements, which are usually embodied as flip-flops, of the shift register considered. The exponents of the terms of f(x), except for the leading term, correspond to the delay elements of the shift register contributing to the feedback. The linear shift register illustrated in FIG. 12 would thus have a characteristic polynomial of the following kind:
f(x)=xⁿ⁺¹+xⁿ+ . . . +x+1.
If such linear shift registers, as are exemplarily illustrated in FIG. 12, are loaded with an initializing state by the initializing means 55, wherein this state is also referred to as the initial state vector, they will typically output a periodic sequence which, depending on the implementation, has a certain pre-period and a subsequent period. Linear shift registers will always be periodic. It is strived for in technological applications for the output sequence to have both a great period length and a high linear complexity.

In principle, pseudorandom number generators, as have, for example, been illustrated referring to FIG. 12, are required for different purposes, that is for simulation purposes, for performing random samples in statistic applications, for testing computer programs, for sequentially ciphering to generate a key sequence, for probabilistic algorithms, in numerical mathematics, in particular for a numerical integration, for generating keys in cryptology or for Monte Carlo methods. In particular, pseudorandom number generators are commercially employed for safety ICs, within typically integrated random number generators, within crypto-modules or for pay TV applications or even in chip cards for cell phones, etc. Basically, random numbers can be generated on the basis of a physically random process or else by certain mathematical manipulations. Only in the latter case, we speak of pseudorandom numbers, while in the first case, we speak of true random numbers. In a pseudorandom number generator, numbers are generated from certain initial values, the so-called seed which is effected by the initializing means 55 of FIG. 12, typically at a very high speed, wherein the numbers must pass a number of tests which true random numbers would also pass. The seed, however, is produced by a true physical random process. As has been illustrated referring to FIG. 12, linear feedback shift registers (LFSR) are used to provide pseudorandom number generators. Shift registers with a linear feedback are of advantage in that they are mathematical theories stating that certain features of the pseudorandom numbers produced can be predicted theoretically. The most important features are the period length and the linear complexity of the output sequence. Thus, there are theories for linear shift registers which make it possible to either exactly predict the output sequence or at least to make statements on the minimum length of the period and the maximum size of the linear complexity. Put differently, lower thresholds for the period length and the linear complexity can be indicated and proved by mathematical processes.

The disadvantage connected to using shift registers with linear feedback as basic building blocks in pseudorandom number generators is that the output sequences have a linear complexity which is relatively small compared to the period length. The reason for this is that the output sequences of an individual shift register with linear feedback already have such a disproportion of period length to linear complexity. When a shift register with linear feedback, for example, includes N memory cells, such as, for example, flip-flops, the period length of the output sequence can at most take the value 2^{N}−1. If the feedback polynomial is selected well, this will really be the case. The linear complexity of the output sequence, however, at most equals N.

In order to increase the period length and at the same time the linear complexity, it would thus be necessary using a shift register with linear feedback to keep on increasing the number of memory cells, which, on the one hand, entails problems as regards the space and which, on the other hand, entails electrical problems since all the memory cells in a shift register must be addressed by a block, wherein synchronization problems are becoming ever more pronounced when the number of memory cells increases.

Additionally, an ever greater number of memory cells within a single shift register has the result that the pseudorandom number generator can be localized ever more easily by an attacker and thus becomes the target of a crypto attack ever more easily. This is of special disadvantage when the pseudorandom number generator contains secret information or operates on the basis of secret information, which will typically be the case when the pseudorandom number generator is used in a cryptographic field.

### SUMMARY OF THE INVENTION

It is the object of the present invention to provide an improved concept for generating pseudorandom numbers.

In accordance with a first aspect, the present invention provides a pseudorandom number generator having: a first elemental shift register having a non-linear feedback feature and a first elemental shift register output; a second elemental shift register having a second elemental shift register output; and combiner for combining the first elemental shift register output and the second elemental shift register output to obtain a combined signal including a pseudorandom number at an output.

In accordance with a second aspect, the present invention provides a method for generating a sequence of pseudorandom numbers, having the following steps: operating a first elemental shift register having a non-linear feedback feature and a first elemental shift register output; operating a second elemental shift register having a second elemental shift register output; and combining signals at the first elemental shift register output and the second elemental shift register output to obtain a combined signal representing a pseudorandom number of the sequence of pseudorandom numbers.

In accordance with a third aspect, the present invention provides a computer program having a program code for performing a method for generating a sequence of pseudorandom numbers when the computer program runs on a computer, wherein the method has the steps of: operating a first elemental shift register having a non-linear feedback feature and a first elemental shift register output; operating a second elemental shift register having a second elemental shift register output; and combining signals at the first elemental shift register output and the second elemental shift register output to obtain a combined signal representing a pseudorandom number of the sequence of pseudorandom numbers.

The present invention is based on the finding that high linear complexities, high period lengths and a flexible usage of hardware resources already present can be obtained by forming the pseudorandom number generator of a plurality of elemental shift registers having non-linear feedback features, and that signals on the outputs of the elemental shift registers are combined with one another to obtain a combined signal, which is, for example, a binary digit of a pseudorandom number.

It is to be pointed out here—in a binary case—a binary digit at the output, of course, already is a random number. Usually, a pseudorandom number with, for example, 8, 16, bits is, however, required. In this case, 8, 16, . . . successive bits at the output of the pseudorandom number generator would, for example, be selected. The bits can be successive or not even though the “withdrawal” of successive bits at the output is preferred.

Depending on the combining rule used which is implemented by combining means, a flexible increase in the linear complexity can be obtained. When a non-linear combining rule is used as combining means, such as, for example, a multiplication, that is an AND gate in the binary case, the linear complexity of a pseudorandom number sequence produced by the inventive pseudorandom number generator, under suitable preconditions, equals the product of the linear complexities of the pseudorandom number sequences generated by the individual elemental shift register having non-linear feedback features. When, however, a linear combination is used, such as, for example, in addition (modulo 2), that is an XOR operation in the binary case, the linear complexity of the output sequence of the pseudorandom number generator equals the sum of the linear complexities of the pseudorandom number sequences generated by the elemental shift registers having a non-linear feedback feature. The usage of elemental shift registers having non-linear feedback features instead of linear feedback features makes it possible for the relations illustrated above as regards linear complexity to apply. In addition, the period length of the pseudorandom number generator sequence will always equal the product of the elemental shift register period lengths themselves.

The inventive pseudorandom number generator concept is of particular advantage in that any number of elemental shift registers having non-linear feedback features can be used and that the outputs thereof can be combined by combining means, wherein the combining means can be formed to be very simple, namely, for example, by only performing an AND operation and/or an XOR operation, that is an addition modulo 2.

By using any number of elemental shift registers in the inventive pseudorandom number generator, there is a high flexibility in producing a special linear complexity or period length for every special application. An individual elemental shift register having non-linear feedback thus need not to be intervened in when a pseudorandom number generator for a different application is required. Instead, the inventive concept makes it possible for every different application to provide a different number of elemental shift registers having non-linear feedback and to couple them by combining means. The developer, however, is provided with a high degree of freedom to generate, for each application, a precisely dimensioned product which, on the one hand, is not over-dimensioned (and is thus cost effective) and which, on the other hand, is not under-dimensioned and thus comprises the period length and the linear complexity for a special application required.

In addition, the inventive concept is of advantage as regards safety and flexibility when designing the circuit since various elemental shift registers can be arranged as special units at positions within an integrated circuit desired by the circuit developer. If, however, the number of memory cells were increased when using a single shift register for increasing the linear complexity, such a shift register arrangement having a large number of memory cells could be recognized ever more clearly compared to different considerably smaller elemental shift registers which, in principle, can be arranged at will on an integrated circuit and thus can hardly be localized by an attacker or not localized at all. In the inventive pseudorandom number generator, the elemental shift registers only have to be connected to combining means which usually also includes one or several gates via a single elemental shift register output line, wherein the combining means can be hidden on an integrated circuit easily and without great efforts.

In summary, the inventive pseudorandom number generator is of advantage in that it can be formed efficiently and scalable for the corresponding requirements on the one hand, and that, on the other hand, it entails the possibility to be arranged on an integrated circuit in a distributed way such that it cannot be localized easily for safety-critical applications.

In preferred embodiments of the present invention, the elemental shift registers used are binary shift registers having a non-linear feedback function, which produce maximally periodic sequences whenever not all the cells of the shift register contain the bit 0. Such a maximally periodic shift register having N memory cells produces output sequences of the period length 2^{N}−1.

In addition, it is preferred for the numbers of memory cells of the elemental shift registers having non-linear feedback features used in a pseudorandom number generator, in pairs, not to have a common divisor. This means that the elemental shift registers which each include a certain number of memory cells, include numbers of memory cells, the greatest common divisor of which equals 1.

In addition, it is preferred for the elemental shift registers used to comprise the additional feature to produce sequences of maximal linear complexity whenever not all the cells of the shift register contain a 0. Such a shift register having N memory cells produces output sequences having a linear complexity of 2^{N-}2. If this feature applies to all the shift registers used, the linear complexity of the output sequence of the pseudorandom number generator has a corresponding maximal value for the linear complexity.

In addition, it is preferred for certain embodiments of the present invention as regards a safe theoretical detectability and predictability for the output sequence to be only used once by each shift register, i.e. only one “wire” comes out of each shift register.

In addition, it is preferred for the output sequences of some shift registers to be multiplied by one another segment per segment (multiplication modulo 2). The product sequences produced in this way are fed to a total adder.

In addition, it is preferred for the output sequence of at least one shift register to be directly fed to the total adder.

Finally, it is preferred the output sequence of the total adder which is part of the combining means to represent the output sequence of the entire pseudorandom number generator. In this context, an XOR operation of several input sequences, that is term by term, that is in the binary case bit by bit, is meant by total adder.

It is particularly preferred to use simple combinations of existing non-linear feedback shift registers since theoretical statements about the period length and the linear complexity of the output sequences can exactly be proved mathematically via these simple combinations. This allows the controlled usage of the inventive shift register having a non-linear feedback feature in pseudorandom number generators.

In addition, it is preferred for the individual elemental shift registers, as has been explained, to be maximally periodic non-linear feedback feature shift registers (MP-NLFSRs). A maximally periodic non-linear feedback feature shift register is an NLFSR having the feature of being able to generate sequences of maximal period length. It is assumed that the shift register has N memory cells. The maximal period length will then be 2^{N}−1. When the memory cells of an MP-NLFSR are occupied by any initial state (the only exception is that not all the cells can contain the bit 0), this MP-NLFSR will always generate a sequence of maximal period length.

Depending on the implementation MP-NLFSRs can be produced in an experimental manner by computer searching. According to the invention, it has been found out that MP-NLFSRs constructed in this way almost always have a very high linear complexity. This means that the output sequence produced by the MP-NLFSR thus not only has a maximal period length of 2^{N}−1, but generally also has a similarly high linear complexity. In particular, the maximal value possible for the linear complexity is 2^{N}−2, wherein this value is sought for the present invention. This observation results from computer experiments on the one side and is also conform with the mathematically proven rule by Meidl and Niederreiter which is illustrated in IEEE Transactions on Informations Theory 48, no. 11, pp. 2817-2825, November 2002.

As has been explained, it is preferred for the numbers of memory cells of the MP-NLFSRs used, in pairs, not to have common divisors among one another. Exact values for the period length and the linear complexity of the output sequence can then be proved mathematically for certain combinations of the MP-NLFSRs, by a formula containing the quantities R, S, T, . . . , wherein R is the number of memory cells of the first maximally periodic non-linear feedback shift register, S is the number of memory cells of the second maximally periodic non-linear feedback shift register, T is the number of the third elemental shift register, etc.

In addition, maximally periodic non-linear feedback shift registers can be used, the output sequences of which do not have the maximal linear complexity but (somehow) smaller values, such as, for example, L1, L2, L3. When such elemental shift registers are combined according to the invention, preferably using a simple combination rule which, for example, only includes an AND or XOR etc. operation, that is a simple logic operation, a formula for the period length and for the linear complexity can also be proved exactly mathematically for the output sequence of the pseudorandom number generator device formed in this way. Such a formula for the linear complexity of the output sequence, however, apart from the quantities R, S, T, . . . , also contains the quantities L1, L2, L3, . . . .

### BRIEF DESCRIPTION OF THE DRAWINGS

Preferred embodiments of the present invention will be detailed subsequently referring to the appended drawings, in which:

FIG. 1 shows a pseudorandom number generator according to a first embodiment of the present invention;

FIG. 2 shows a pseudorandom number generator according to a second embodiment of the present invention;

FIG. 3 shows a pseudorandom number generator according to a third embodiment of the present invention;

FIG. 4 shows a pseudorandom number generator according to a fourth embodiment of the present invention;

FIG. 5 shows a pseudorandom number generator according to a fifth embodiment of the present invention;

FIG. 6 shows a preferred setup of an elemental shift register having non-linear feedback;

FIG. 7 shows an alternative setup for an elemental shift register having non-linear feedback;

FIG. 8 shows an alternative setup for an elemental shift register having non-linear feedback;

FIG. 9 shows an alternative setup for an elemental shift register having a non-linear feedback feature;

FIG. 10 shows an exemplary setup for an elemental shift register having non-linear feedback;

FIG. 11 is a general illustration of an elemental shift register with memory cells in the feedforward means and feedback function F; and

FIG. 12 shows a well-known linear shift register for producing a random number sequence.

### DESCRIPTION OF THE PREFERRED EMBODIMENTS

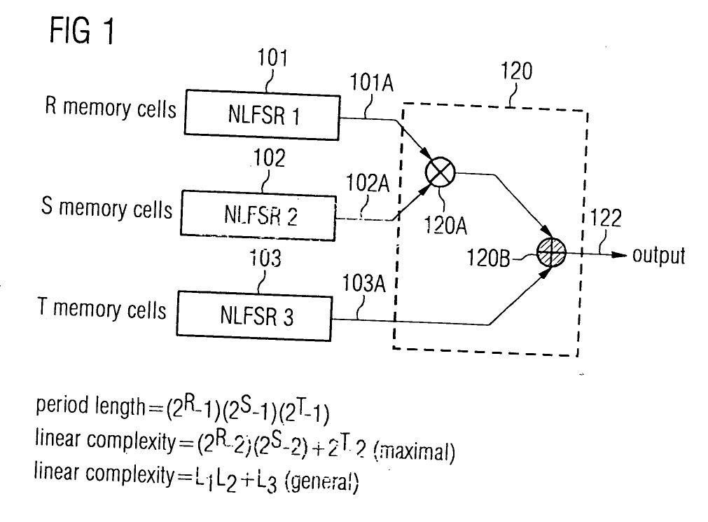

FIG. 1 shows a pseudorandom number generator according to a first embodiment of the present invention. The pseudorandom number generator includes a first elemental shift register 101 having a non-linear feedback feature and a first elemental shift register output 101a and a second elemental shift register 102 which preferably also has a non-linear feedback feature. The second elemental shift register, as does the first elemental shift register 101, also includes a second elemental shift register output 102a. The two elemental shift register outputs 101a, 102a are combined by means of combining means which, in FIG. 1, is generally designated by 120. The combining means 120, on the output side, provides a combined signal on an output line 122 which—over the time—includes a pseudorandom number sequence and, preferably a bit sequence.

The inventive pseudorandom number generator can principally consist of two elemental shift registers 101, 102, wherein at least one, but preferably both, comprise/s a non-linear feedback feature, as has been shown referring to FIG. 1. In a preferred embodiment, the number of elemental shift registers which preferably all have a non-linear feedback feature, is greater than 2 so that the embodiment shown in FIG. 1 results which includes a third elemental shift register 103 which, like the two elemental shift registers 101 and 102, preferably also has a non-linear feedback feature and which additionally comprises a third elemental shift register output 103a. In this case, that is when three or more elemental shift registers are used, the combining means 120 is preferably formed in two parts so to speak, in that it includes both a multiplier 120a and an adder 120b. It is preferred in the binary case that the multiplier performs a multiplication modulo 2, that is an AND operation on two bits. In addition, it is preferred for the adder 120b to perform an addition modulo 2—in the binary case—that is an XOR operation on two bits. It is, however, to be pointed out that, in principle, it is preferred for reasons of the theoretical predictability for the combining means only to include simple basic logic functions, such as, for example, AND, NAND, OR, NOR, XOR, XNOR, etc. The logic functions, can, as becomes obvious from the example shown in FIG. 1, occur in the combining device either together or separately depending on a certain design desired.

In the preferred embodiments, it is preferred due to the simplicity of the implementation and due to the possibility of the theoretical predictability that the combining means only include one or several AND gates and one or several XOR gates, as is principally illustrated referring to FIG. 1.

When a pseudorandom number generator is formed of only two elemental shift registers, that is the second elemental shift register 102 is not present in the embodiment shown in FIG. 1, and instead there is only the third elemental shift register 103, the combining means, contrary to the other case in which the third elemental shift register 103 is present, includes only the adder, that is the XOR operation 120b instead of the AND operation, that is the multiplier 120a.

Additionally, it is preferred for the feedforward means of the shift registers 101, 102, 103 to comprise R memory cells, S memory cells and T memory cells. In a preferred embodiment of the present invention, the number of the memory cells for the individual elemental shift registers should, in pairs, not have a common divisor. Thus, the following applies to the embodiment illustrated in FIG. 1: gcd(R,S)=1, gcd(R,T)=1 and gcd(S,T)=1, wherein gcd(A,B)=is the greatest common divisor of the integers A and B. This means that in a preferred embodiment R=19, S=20 and T=21. Alternatively, it would also be possible to select R=23, S=25 and T=27 or R=29, S=30 and T=31. The triplet R=24, S=25 and T=27 would, however, be illegal because the numbers 24 and 27 contain the common divisor 3 which is unequal to the maximally allowed common divisor 1.

It is additionally preferred for the shift registers 101, 102, 103 used to be of maximal periodicity, i.e. taken individually, produce the following period lengths 2^{R}−1, 2^{S}−1 and 2^{T}−1, respectively, wherein R, S and T are the numbers of memory cells in the respective elemental shift registers. In addition, it is preferred for the individual elemental shift registers to be able to produce output sequences of maximal linear complexity. In this way, that output sequence of the R cell shift register 101 is to have a linear complexity of 2^{R}−2. Here, the linear complexity is only smaller by “1” than the period length, which is only possible because the elemental shift register 101 has a non-linear feedback feature.

Alternatively, it is not necessarily required for the maximally periodic shift registers used to have output sequences of the maximal linear complexity. Thus, a smaller linear complexity also results for the output sequence of the entire inventive pseudorandom number generator, which, however, is not critical for certain applications.

As can be seen from FIG. 1, the preferred pseudorandom number generator illustrated there provides an output sequence having a period length equaling the product of the period lengths of the individual elemental shift registers 101, 102, 103. Additionally, a greater linear complexity results since the multiplier 120a has the result that the linear complexities of the two elemental shift registers 101, 102 are multiplied. The linear complexity of the third elemental shift registers 103 is added to the product of the linear complexities of the two elemental shift registers 101, 102 due to the adder 120b in the combining means so that the result is a total linear complexity of the output sequence of the inventive pseudorandom number generator shown in FIG. 1, as is illustrated by means of equations in FIG. 1.

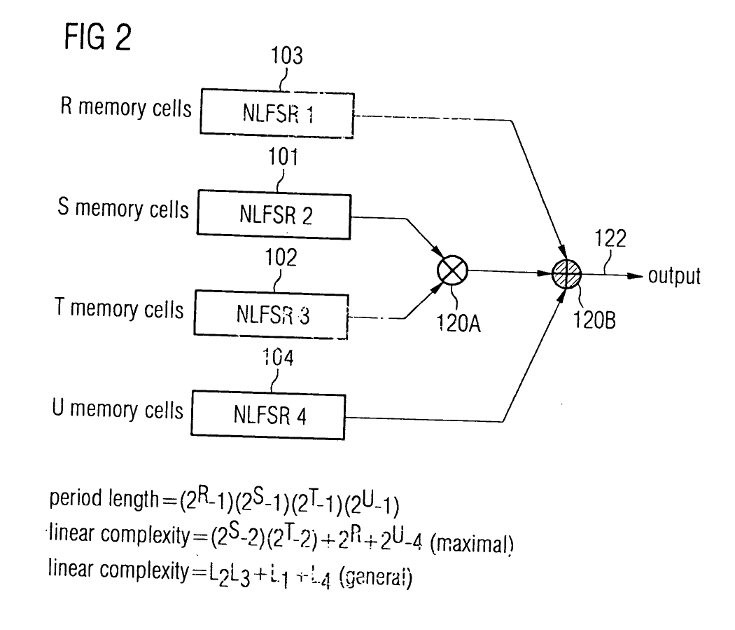

The preferred embodiment for a pseudorandom number generator according to the present invention illustrated in 30 FIG. 2 differs from the embodiment illustrated in FIG. 1 by the fact that another non-linear shift register 104 is provided. Thus, the two first elemental shift registers 101, 102, as is illustrated in FIG. 1, are combined with each other by the multiplier 120a, while the output signal of the multiplier 120a, as is illustrated in FIG. 1, is added to the output signal of the elemental shift register 103. Unlike in FIG. 1, the output signal of the fourth elemental shift register 104 is also added to this using an adder 120b now having three inputs.

The period length can, as is shown in FIG. 2, be increased using a fourth elemental shift register 104, not additively but multiplicatively. In addition, the linear complexity is also increased by the fourth shift register even though it only contributes additively, but does not contribute multiplicatively.

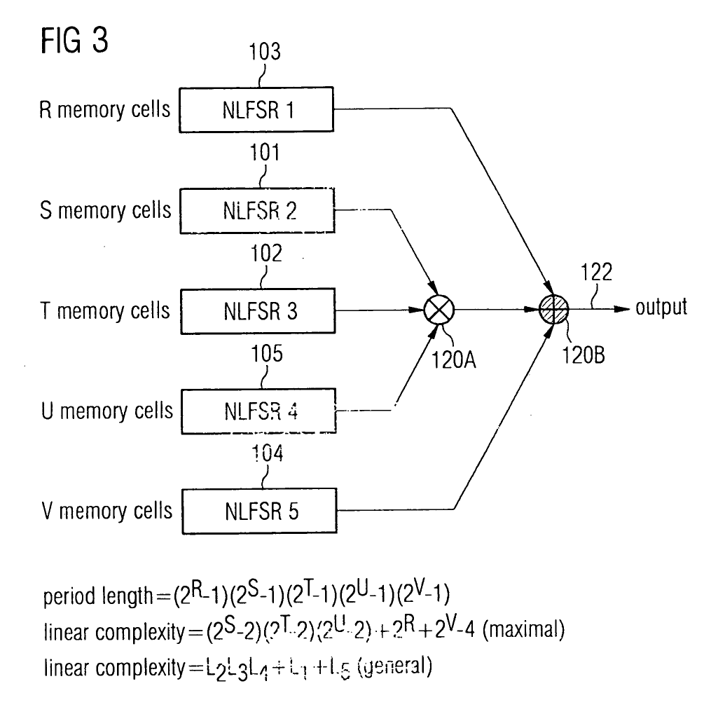

Another embodiment of the present invention is shown in FIG. 3, wherein FIG. 3 differs from FIG. 2 by the fact that there is another elemental shift register 105, the elemental shift register output of which is also fed to the multiplier 120a as are the corresponding outputs of the first and second elemental shift register. Here, the period length is again increased multiplicatively. It is important that the linear complexity, too, be increased multiplicatively, as is illustrated referring to the equations shown in FIG. 3.

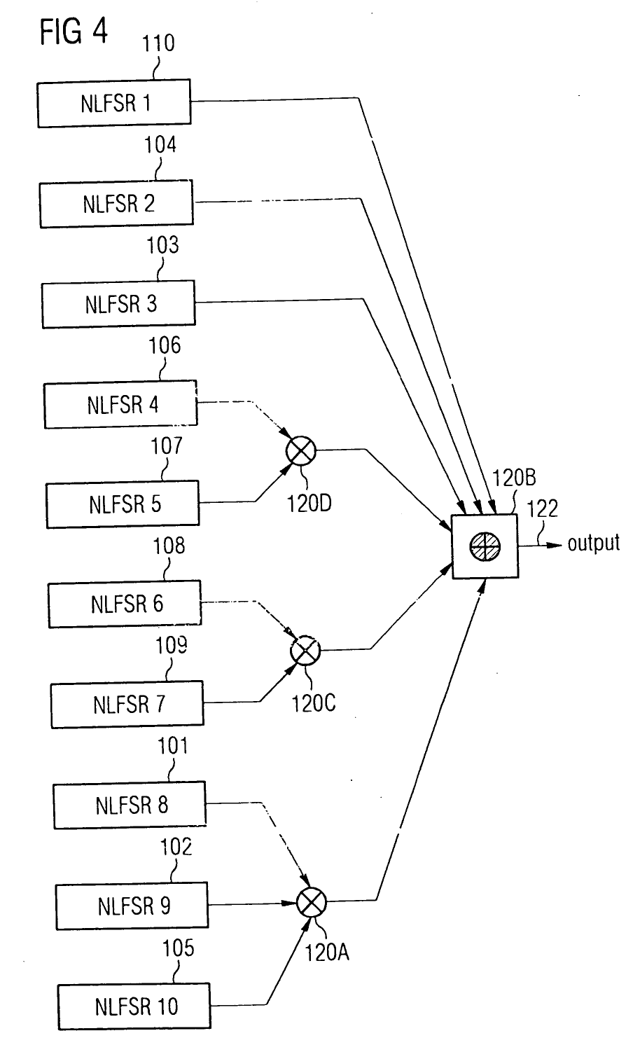

Another alternative of the present invention is illustrated in FIG. 4. Here, 10 elemental shift registers 101 to 110 are used which, as is illustrated referring to FIG. 4, are combined with one another by combining means which now does not only include a multiplier 120a and an adder 120b, but which, in the example shown in FIG. 4, additionally includes further multipliers 120c, 120d. It is to be pointed out that in all the shift registers, the outputs connected to different multipliers 120a, 120c, 120d could, of course, also be connected to a single multiplier which has a total of seven inputs. On the output side, all the outputs of the multipliers 120a, 120c, 120d and all the outputs of the elemental shift registers 103, 104, 110 which are not fed to the multiplier are fed to the adder 120b to obtain a pseudorandom number sequence at a total output 122.

It is to be mentioned at this point that it is generally preferred to use combining means which is formed such that at least two elemental shift register outputs are combined multiplicatively and such that the output signal of the multiplicative combiner, that is of the multiplier 120a, 120c and 120d, respectively, is fed to a total adder 120b which additionally includes all the elemental shift register output signals of the other elemental shift registers not connected to a multiplier and which itself has an output which coincides with the total output 122 of the inventive pseudorandom number generator. Such an arrangement is preferred for reasons of a better predictability and thus a safer usability of the inventive shift registers.

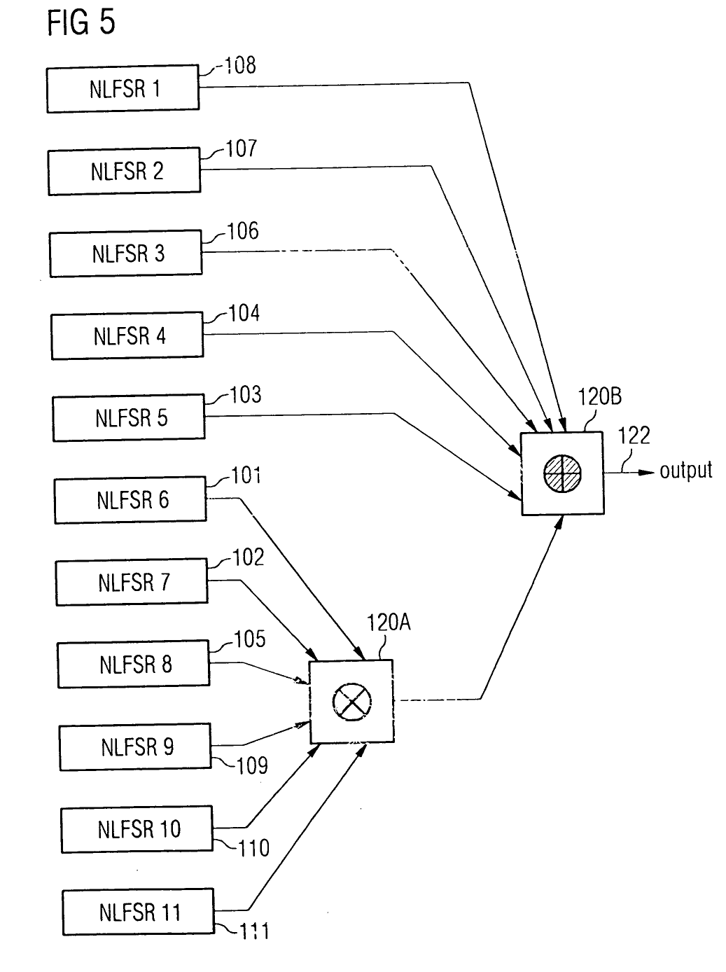

FIG. 5 shows an alternative embodiment for an inventive pseudorandom number generator wherein a total of 11 elemental shift registers are used which preferably all have a non-linear feedback feature. In this way, the elemental shift register output lines of the elemental shift registers 101, 102, 105, 109, 110, 111 are linked by the multiplier 120a, while the elemental shift register output lines of the elemental shift registers 103, 104, 106, 107, 108, together with the output of the multiplier 120a are linked via the total adder 120b to obtain—over the time—a pseudorandom number sequence at an output 122.

In a preferred embodiment of the present invention all the circuits have a binary character. This means that each elemental shift register generates a sequence of bits on the output side, that is at the outputs 101a, 102a, 103a of FIG. 1, wherein each bit of the individual sequence of bits is associated to a clock cycle which is provided by a control clock not shown in FIGS. 1 to 5. In this case, bits on the output lines 101, 102, 105, 109, 110, 111 of FIG. 5, for example, which all belong to the same control block are added by the adder 120a, the output of which thus also includes a sequence of pseudorandom numbers the linear complexity of which equals, in analogy to the formulae which have been explained referring to FIGS. 1 to 3, the product of the linear complexities of the shift registers 101, 102, 105, 109, 110, 111 and the period length of which equals the product of the period lengths of the individual shift registers 101, 102, 105, 109, 110, 111.

This sequence is then—also bit by bit—added to the output sequences of the shift registers 103, 104, 106, 107, 108 of FIG. 5 by the total adder 120b.

It is to be pointed out that delays introduced by the multiplier 120a are insignificant since it is an arbitrary selection anyway which memory cell within an elemental shift register including a feedback loop the output sequence of an elemental shift register is extracted from. Put differently, it is an arbitrary selection which memory cell of the plurality of memory cells within an elemental shift register the elemental shift register output line is connected to. Thus, it is also insignificant how big a delay a multiplier 120a introduces. Additionally, it is not required for all the individual shift registers to be clocked by the same clock or, put generally, to be clocked with the same speed as long as an addition by the adder 120b or a multiplication by the multiplier 120a, respectively, is ensured in order for a continuous sequence of random numbers to be obtained at the output 122. It is not important whether, in relation to an absolute point in time, sequences shifted to one another of the elemental shift registers or sequences developing within the combining means, such as, for example, at the output of the multiplier 120a, are combined in a shifted or non-shifted way.

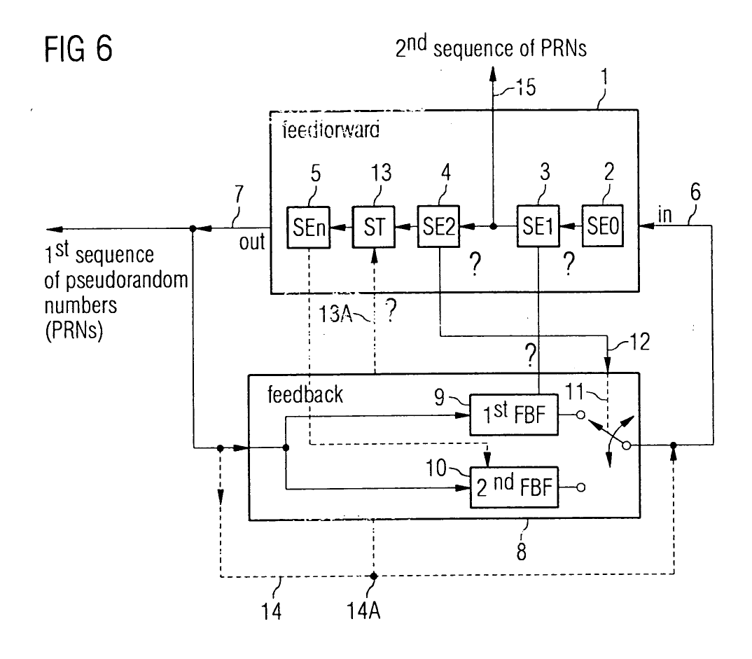

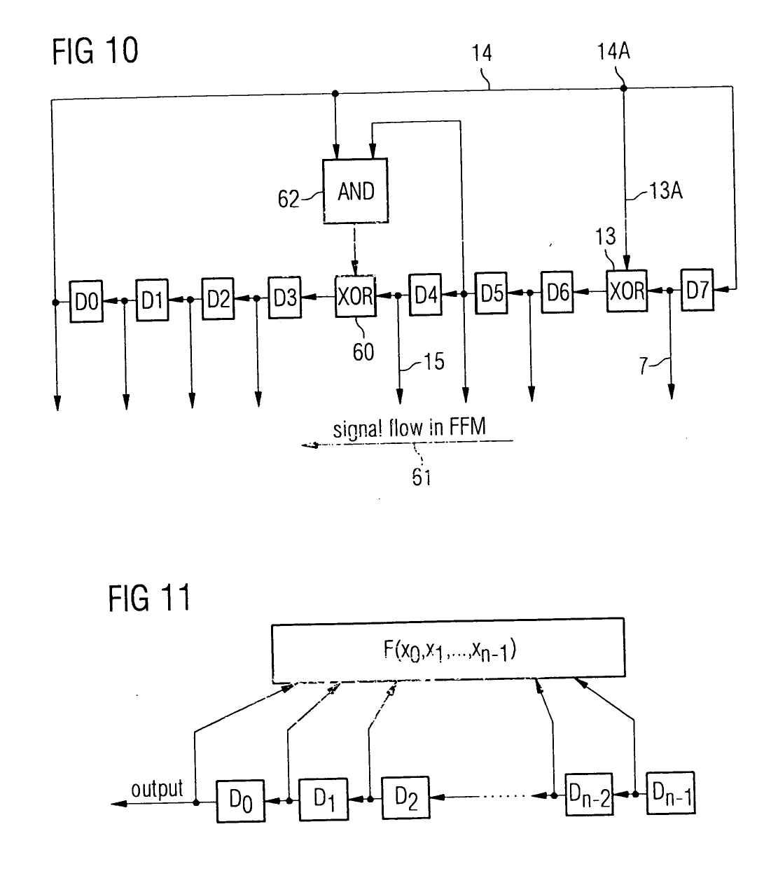

It is to be pointed out in anticipation of FIG. 6 that sequences of pseudorandom numbers can be extracted from each elemental shift register having several memory cells at many positions. Thus, in the embodiment shown in FIG. 6, the first sequence of pseudorandom numbers can, for example, be extracted at the output of the memory cell 5 which is designated by SEn. Additionally or preferably alternatively, even the second sequence of pseudorandom numbers can be extracted at the output of the memory cell 3 which is designated by SE1. The same applies to FIG. 9 where a sequence can, for example, be output from the elemental shift register at the output of the memory cell 2 or alternatively, at the output of the memory cell 3 which is designated by “15”. Many different possibilities are shown in FIG. 10 where sequences can be extracted, that is at the output of the memory cells D7, D6, D5, D4, D3, D2, D1 or D0.

Subsequently, referring to FIGS. 6 to 10, a number of different embodiments for embodying the individual elemental shift registers 101-111 in FIGS. 6 to 9 will be given. It is also pointed out that not all the shift registers, such as, for example, in FIG. 5 the shift registers 101-111, must have the same setup but may have different setups as long as at least one and preferably all of the shift registers has/have a non-linear feedback feature.

FIG. 6 shows an elemental shift register having non-linear feedback for generating a pseudorandom sequence of numbers with feedforward means 1 comprising a sequence of memory units 2 to 5 and additionally including input 6 and output 7 which corresponds to the output of the device for outputting the sequence of pseudorandom numbers. It is to be pointed out that the sequence of pseudorandom numbers can be supplemented by further means not shown in FIG. 6 to buffer sequences of random numbers, to combine them in another way, etc.

The device shown in FIG. 6 further includes feedback means 8 having a variable feedback feature and coupled between the input 6 and the output 7 of feedforward means 1. The variable feedback feature of the feedback means 8 is illustrated in FIG. 6 in that the feedback means 8 can take a first feedback feature 9 or a second feedback feature 10, wherein switching between the first feedback feature 9 and the second feedback feature 10 can, for example, take place by means of switching means 11. The control signal for the switching means 11 is only exemplarily provided by the fourth memory means SE2, as is symbolically illustrated by a signal path. The first feedback feature 9 and the second feedback feature 10 differ in the embodiment shown in FIG. 6 in that in the case of the first feedback feature the state of the memory means 1 (No. 3) enters into feedback while in the case of the second feedback feature the state of the memory means 5 (SEn) contributes to feedback.

Alternatively or additionally, the feedback means 8 can be formed such that in the feedback feature combining the value at the output 7 of the feedforward means with an inner state of the feedforward means, a different combining rule is used depending on the feedback features selected. In this way, a AND combination could be used for example in the first feedback feature for combining the value at the output 7 and the value of the register cell 3, while the second feedback feature differs from the first feedback feature in that it is not an AND but an OR combination that is used for combining the two values mentioned. It is obvious for those skilled in the art that different types of different combination rules can be employed.

In addition, values of the memory means SE1 and SEn, respectively, need not be fed directly to combining means in the feedback means, but these values can, for example, be inverted, combined with one another or processed non-linearly in any way before the processed values are fed to combining means.

In addition, it is not essential for the switching means 11 to be controlled directly by the state of the memory unit SE2. Instead, the state of the memory means SE2 could be inverted, processed logically or arithmetically in any other way or even combined with the state of one or several further memory means as long as a device for generating a pseudorandom sequence of numbers having a feedback means is obtained the feedback feature of which is not static but can varied dynamically depending on the feedforward means and, in particular, on one or several states in memory units of the feedforward means.

In the feedforward means 1 of FIG. 6, additionally control means 13 arranged between two memory elements, namely in the example shown in FIG. 6 between the memory elements 4 and 5, is incorporated. Since there is a signal flow from the memory element 0 to the memory element n in FIG. 6, the memory element 4 is the memory element arranged in front of the control means as far as the signal flow is concerned, while the memory element 5 is the signal arranged after the control means as far as the signal flow is concerned. The control means 13 has a control input 13a which can be provided with a control signal which, in principle, can be any control signal.

The control signal can, for example, be a true random number sequence so that the output sequence of the shift register arrangement is a random number sequence. The control signal can also be a deterministic control signal so that a pseudorandom number sequence is obtained on the output side.

The control input 13a, however, is preferably connected to the feedback means 8, as is illustrated in FIG. 6 by the corresponding broken line, such that a signal in the feedback means provides the control signal for the control means 13 which means that the control signal is a deterministic signal, too.

Even though the feedback means 8 in the embodiment shown in FIG. 6 is designated to be a variable feedback means, the feedback means can also be feedback means having a constant feedback feature, as is represented by a broken line 14. In this case, the control signal for the control input 13a would be derived from a branching point 14a, as is schematically illustrated in FIG. 6 by the broken line from point 14a to the control input 13a of the control means 13.

In addition, the elemental number sequence generator shown in FIG. 6, to increase efficiency, is used to produce, for example, not only a sequence at the output 7 but also a second sequence of preferably pseudorandom numbers at another input 15, wherein both sequences or only one sequence of the two sequences are/is fed into combining means. Incorporating the control means 13 has the effect that the sequence output at the output 7 is really different from the sequence output at the output 15, wherein the two sequences are not shifted towards another but, as has been explained, are really different since they are “extracted” before and after the control means 13, respectively, as far as the signal flow is concerned.

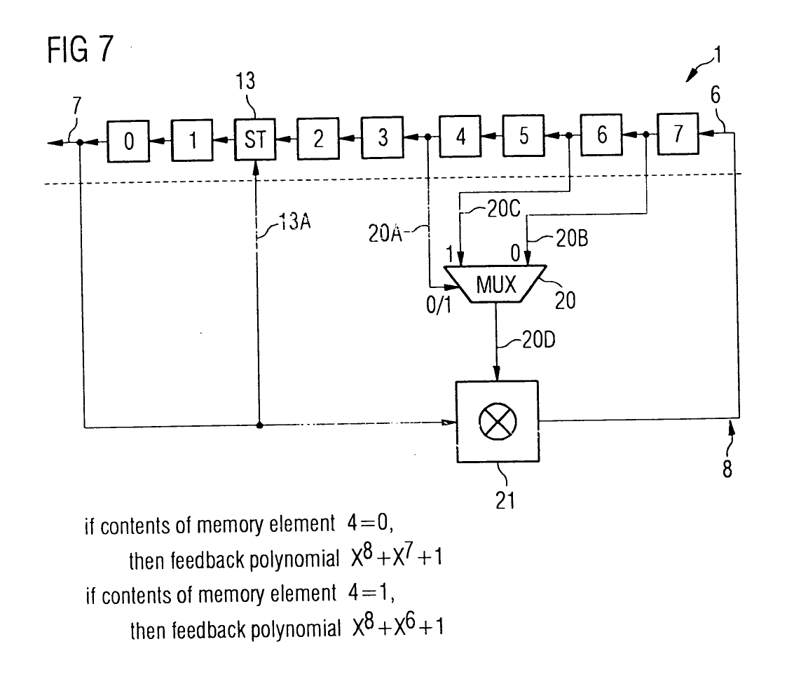

FIG. 7 shows an 8-bit shift register, wherein a multiplexer 20 is controlled via a control input 20a depending on the state of the memory means no. 4. If the control input 20a is in a zero state, i.e. if there is a zero state in the memory cell no. 4, the multiplexer will be controlled such that it connects the state of the memory means no. 7 at a first input line 20b of it to an output line 20d. This would correspond to the effect of a linear shift register having the following feedback polynomial:
x⁸+x⁷+1

If the control input 20a is, however, in a one state, the state of the memory means no. 6 will be connected to the output line 20d of the multiplexer 20 at a second input 20c. The output line 20d is connected to combining means 21 which, in the embodiment shown in FIG. 7, is also fed the value at the output 7 of the feedforward means, which at the same forms the output of the device for generating a pseudorandom sequence of numbers. The result calculated by combining means 21 in turn is fed to the first memory means no. 7 in FIG. 7.

If the contents of the memory cell no. 4 equals 1, there will be the following feedback polynomial:
x⁸+x⁶+1
It becomes evident from the above description that switching between the two mentioned feedback polynomials takes place depending on the contents of the memory cell no. 4 of the feedforward means 1.

It has been found out that the linear complexities of sequences obtained according to the invention are high, namely between 234 and 254 when the shift register has 8 flip-flops. It is to be pointed out that the period length of a sequence produced by any 8-step shift register can, as a maximum, be 255. The maximal value for the linear complexity of such a sequence is 254.

The most simple of all 8-step elemental shift registers which can produce a sequence is the shift register illustrated in FIG. 7 having the two feedback polynomials illustrated in FIG. 7. As regards the theory of the linear shift registers as a comparative example, it is to be pointed out that there are 16 degree 8 primitive polynomials. Each such polynomial describes a linear shift register which can produce a sequence of the period length 255 and the linear complexity 8. In contrast, there are many more shift registers—namely 2020—according to the present invention which can produce the sequences of the period length 255 according to the present invention.

In addition, the sequences which are produced by the inventive shift registers have much greater linear complexities than their analog embodiments according to the prior art. As has been explained, the embodiment shown in FIG. 7 is preferred among all the possibilities examined for an 8-bit shift register having feedback means since it incurs the lowest hardware costs, at the same time has a maximal period duration and additionally comprises a maximal linear complexity.

Control means 13 is further arranged between two memory elements in FIG. 7, wherein these are memory elements 1 and 2. The control means 13 is provided with a control signal which is extracted from the feedback means 8 having a variable feedback feature. Of course, the signal for the control means can also be “extracted” after the XOR gate 21 as far as the signal flow is concerned. In addition, the control means 13 can, of course, also be formed between any two other memory cells, such as, for example, between the memory cells 5 and 6 or between the memory cells 0 and 7, i.e. either, in the signal flow direction, after the memory cell 0 so that the signal at the output of the memory means is directly output at the output 7 or directly before the memory cell 7.

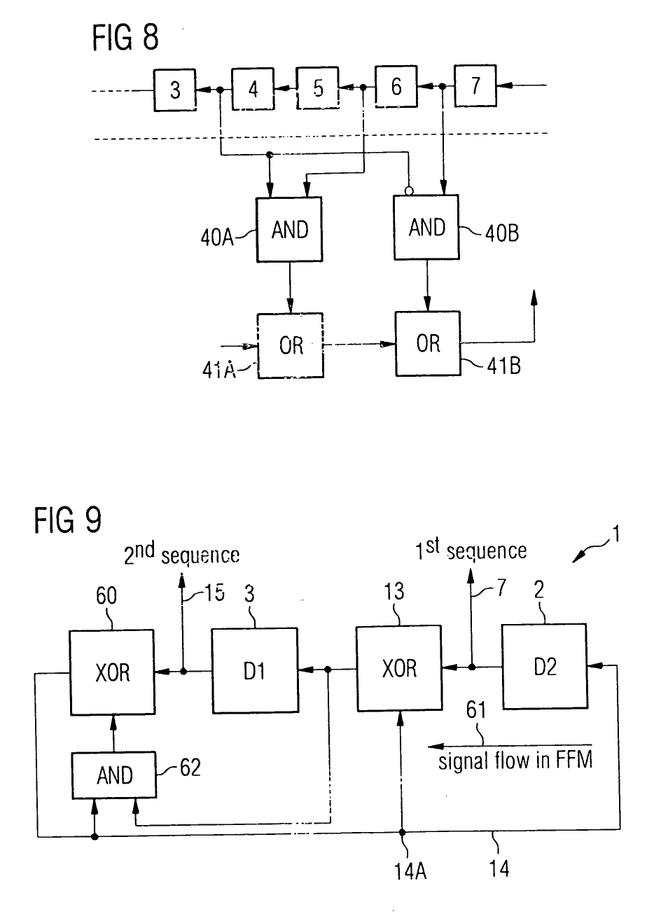

It is, however, preferred for reasons of signal processing for all the signals, such as, for example, output sequences, control signals and data signals for the multiplexer, etc., to be extracted at the output of shift registers so that the shift register, apart from its functionality for producing the number sequence, also serves to provide stable signals for logic gates. Thus, corresponding output stages for logic gates need not be produced when control signals or output signals are extracted from the outputs of the logic gates themselves. Subsequently, reference will be made to FIG. 8 to illustrate a special implementation of the multiplexer means 20 of FIG. 7. The multiplexer 20 can easily be implemented by two AND gates 40a, 40b which are both connected to OR gates (or XOR gates) 41a, 41b coupled in series, as is shown in FIG. 8. In particular, the state of the memory cell 4 is fed to the first AND gate 40a, while the inverted state of the memory cell 4 is fed to the second AND gate 40b. For determining the corresponding feedback polynomial, the contents of the memory cell 6 is fed to the first AND gate 40a as a second input, while the contents of the memory cell 7 is fed to the second AND gate 40b and a second input. Additionally, it is to be pointed out that the two OR gates 41a, 41b connected in series could be implemented in an alternative way. When, however, implementations are required in which each logic gate has two inputs and an output, the illustration exemplarily shown in FIG. 8 will be of advantage.

In a method for generating a pseudorandom sequence of numbers from an elemental shift register using a feedforward means 1 having a plurality of memory means having an input and an output for outputting the sequence of numbers, and feedback means comprising a variable feedback feature and connected between the input and the output, a step of initializing the memory means in the feedforward means to a predetermined initial value will be performed at first.

Responsive to the state of a memory means of the plurality of memory means of the feedforward means, the control means will then be controlled in another step depending on the feedback signal. Subsequently, the state of a memory means connected to the output of feedforward means 1 is output to obtain a number of the sequence of random numbers. After this, a decision block is performed to examine whether further random numbers are required. If this question is answered with a no, the process ends here. If it is, however, determined that further numbers are required, the decision block will be answered with a “yes”, whereupon another step follows in which the plurality of memory means are reoccupied based on a previous state of the memory means and on an output of the feedback means. The steps of controlling the control means, outputting and reoccupying are repeated as often as desired in a loop to finally obtain a pseudorandom sequence of numbers.

It is to be pointed out that this method can be performed using a regular clock or even using an irregular clock even though the version having the regular clock is preferred as far as an improved safety against power or time attacks is concerned.

In the case of the linear shift register illustrated in FIG. 7, it is pointed out that reoccupying the plurality of memory means takes place in a series, based on the previous state of the memory means which—taken as a whole—is shifted by one step to the left so that one state of the memory means 0 “drops out” on the output side. This “dropped out” value is the number which will be output. The memory means number 7 in FIG. 7 to the very right can be reoccupied by left shifting the entire state of all the memory means considered. The plurality of memory means and, in particular, memory means 7 are thus reoccupied depending on an output of the feedback means at the actual clock point in time.

FIG. 9 shows an alternative embodiment in which the alternative of the feedback means referred to by the reference numeral 14 in FIG. 6 is illustrated. In particular, the feedback means 14 in FIG. 9 is formed such that it does not have a variable feedback feature but has a constant feedback feature. The inventive advantages are obtained by arranging at least one control means 13 and preferably another control means 60 in the feedforward means.

In the embodiment shown in FIG. 9, the control means 13 is controlled with a control signal which is directly derived from the feedback means 14. In the feedforward means shown in FIG. 9, only two memory means 2 and 3 are provided, wherein the first control means 13 is connected between the memory cells 2 and 3, while the second control means 60 is connected between the memory cell 3 and the memory cell 2 (via the feedback means 14). In addition, a signal flow is marked by an error 61 in FIG. 9, which represents the signal flow in the feedforward means which in the embodiment shown in FIG. 9 is from the right to the left hand side. A bit at first reaches the memory means D2. The bit stored in D2 is output and forms a bit of the first sequence. At the same time, the bit output by the memory means 2 is XOR-ed in the embodiment shown in FIG. 9 with the bit just applying at the feedback means 14 to obtain a result bit which will then be clocked into the memory element 3 in the next cycle at an output of the XOR operation. Thus the bit just present in the memory element 3 will be clocked out of the memory element 3 and thus represents a bit of the second pseudorandom sequence of numbers. The bit at the output of the memory cell 3 is then XOR-ed with a control signal for the second control means 60, wherein the control signal is produced from the signal on the feedback means 14 and the output signal of the first control means 13 by means of combining means. The combining means 62 preferably is a logic gate and, in particular in the embodiment shown in FIG. 9, an AND gate. The first sequence is output via an output 7, while the second sequence is output via an output 15. The two sequences output via the outputs 7 and 15 are really different and not only phase-shifted as regards each other.

In order to simplify the implementation of the XOR gate 60, another memory element is provided in another preferred embodiment after the XOR gate 60 in the signal flow direction, wherein at the output of this memory element a sequence which is only phase shifted to the first sequence at the output 7 which is, however, different in principle to the second sequence at the output 15 will be output.

FIG. 10 shows an 8-bit elemental shift register with flip-flops D0-D7 which are connected in series, wherein additionally the second control means 60 is provided between the fourth and third flip-flops, while the first control means 13 is provided between the seventh and sixth flip-flops. The first control means 13 is again fed directly with the feedback signal on the feedback means 14, while the second control means 60 is provided with the output signal of the AND gate 62 which in turn is fed on the one hand by the feedback means 14 and on the other hand by the output signal of the fifth cell D5. In analogy to the embodiment shown in FIG. 9, the output sequence of the fourth cell D4 represents the second pseudorandom number sequence, while the output sequence of the seventh cell D7 represents the first random number sequence.

The embodiments shown in FIGS. 9 and 10 for an elemental shift register differ in that two further register cells D5, D6 are connected between the two control means and that further memory cells D0 to D3 are formed at the output of the XOR control means 60 so that an 8-bit shift register is formed. In an embodiment, a pseudorandom number sequence is extracted at the output of each memory cell D0-D7 and fed to combining means to obtain a particularly efficient pseudorandom number generator. In particular, the two sequences output by the cells D4 and D5 are shifted versions of the sequence output by the cell D6. In addition, the four sequences output by the cells D2, D1, D0 and D7 are shifted versions of the sequence output by the cell D3. Thus, each sequence of the cells D7, D0, D1, D2, D3 is essentially different to a sequence of the cells D4, D5, D6.

It is to be pointed out that the initial state which the shift register is initialized to, that is so-called seed explained referring to FIG. 7, element 55, is to be designed such that it at least includes a value for a memory element which is unequal to zero in order for the shift register to somehow “start up” and not to output eight zero sequences at the eight outputs. Subsequently, when this condition is fulfilled, all the eight sequences have a maximum periodicity, that is have a period length of 255. In addition, each of the eight sequences output in the embodiment shown in FIG. 10 has a maximal linear complexity of 254. Furthermore, as has already been explained, the two sequences output by the cells D3 and D6 are essentially different.

As can also be seen from FIG. 10, memory cell D5 here is the control cell. If the cell D5 contains a 0, the effect of the control means 60 between the cells D3 and D4 will be suppressed. Only the XOR between the cells D6 and D7 will then be applied. If the cell D5, however, includes a 1, both XOR means 13 and 60 will be used.

FIG. 11 shows a general feedback shift register having memory cells D₀, . . . , Dₙ₋₁ with feedforward means and feedback means which is referred to by F(x₀, x₁, . . . , xₙ₋₁).

A general n-step (or n-cell) feedback shift register over the base element GF(2)={0,1} is assumed here. The shift register includes n memory cells (flip-flops) D₀, D₁, Dₙ₋₁ and the (electronical) realization of a feedback function F(x₀, x₁, . . . , xₙ₋₁). The feedback function associates an unambiguous value from GF(2), that is the value 0 or 1, to each n tuple including n bits. In mathematical terminology, F is a function with a definition domain of GF(2)ⁿ and a target domain of GF(2).

The shift register is controlled by an external clock. The contents of the memory cell Dⱼ is shifted to the left neighboring cell Dⱼ₋₁ with each clock, wherein 1≦j≦n−1. The contents of the memory cell D₀ is output. If the contents of the memory cells D₀, D₁, . . . , Dₙ₋₂, Dₙ₋₁, at a time t, are given by
sₜ, sₜ₊₁, . . . , sₜ₊ₙ₋₂, s_{t+n-1,}
the memory cells, one clock later, that is at a time t+1, will contain the bits
sₜ₊₁, sₜ₊₂, . . . , sₜ₊ₙ₋₁, sₜ₊ₙ,
wherein the value sₜ₊ₙ entering the cell Dₙ₋₁ is given by
sₜ₊ₙ=F(sₜ, sₜ₊₁, . . . , sₜ₊ₙ₋₁)

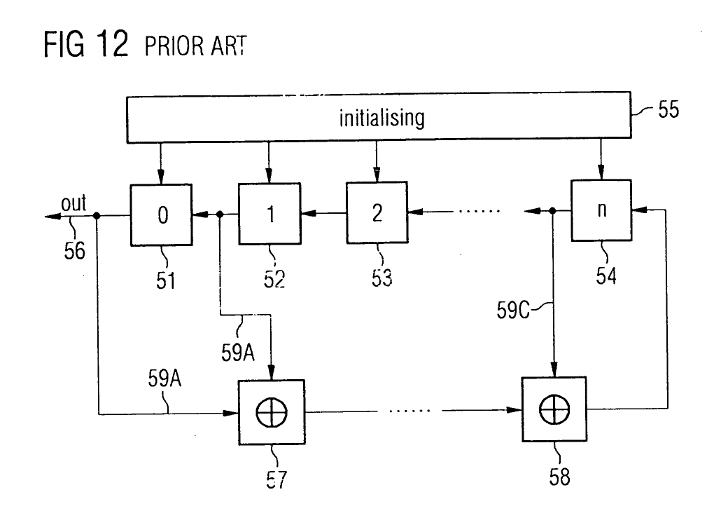

The n tuple (sₜ, sₜ₊₁, . . . , sₜ₊ₙ₋₁) describes the state of the shift register at a time t. The n tuple (s₀, s₁, . . . , sₙ₋₁) is called the initial state. FSR(F) is used as an abbreviation for the general feedback shift register having a feedback function F (FSR stands for feedback shift register). FIG. 12 shows a general feedback shift register.

The shift register outputs one bit with each clock of the external clock. In this way, the shift register can produce a periodic bit sequence s₀, s₁, s₂, . . . , a so-called shift register sequence. s₀, s₁, . . . , sₙ₋₁ are to be taken as initial values of the shift register sequence. The feedback function F(x₀, x₁, . . . , xₙ₋₁) and the initial values s₀, s₁, . . . , sₙ₋₁ completely determine the shift register sequence. Since there are only 2ⁿ different states for the shift register, the period length of the shift register sequence s₀, s₁, s₂, . . . is at most 2ⁿ.

A general feedback shift register FSR(F) will be called homogenous if its feedback function F is homogenous, i.e. if F(0, 0, . . . , 0)=0. A homogenous shift register put in the initial state s₀=s₁= . . . =sₙ₋₁=0 will produce the zero sequence. It follows that the period length of the output sequence of an n-step homogenous shift register can at most be 2ⁿ−1. When the period length has the maximum value of 2ⁿ−1, the shift register sequence is called an M sequence and the shift register is at a maximum. It is an important task to find maximum shift registers.

Two special cases of the general feedback shift register FSR(F) are of particular interest. In one case, the feedback function F has the form:

$$F ( {x}_{0} , {x}_{1} , … , {x}_{n - 1} ) = {\sum }_{0 \leq i \leq j \leq n - 1} {a}_{ij} {x}_{i} {x}_{j}$$

wherein the coefficients aᵢⱼ are either 0 or 1. In this case, this is called a squared feedback function as an example for a non-linear feedback function and the expression squares is also transferred to the shift register.

The other special case is when the feedback function F is linear. In this case, F has the following form:
F(x₀, x₁, . . . , xₙ₋₁)=a₀x₀+a₁x₁+ . . . +aₙ₋₁xₙ₋₁,
wherein the coefficients aᵢ occurring are again 0 or 1, that is elements of GF(2). In this case, this is called a linear or a linear feedback shift register and the abbreviation LFSR (linear feedback shift register) is used for this. It is to be noted that both the linear feedback as well as the squared feedback shift registers are homogenous.

An n-step linear feedback shift register is usually characterized by a binary degree n polynomial f(x) in a variable x. This polynomial f is called the characteristic polynomial of the linear feedback shift register. The shift register is then indicated as LFSR(f).

The feedback function F(x₀, x₁, . . . , xₙ₋₁) of a linear feedback shift register is a polynomial in n variables x₀, x₁, . . . , xₙ₋₁ and of degree 1. In contrast, the characteristic polynomial f(x) of the same linear shift register is a polynomial of only one variable, namely the variable x, but of degree n. The following applies:
f(x)=xⁿ+F(1, x, x², . . . , xⁿ⁻¹)

The nonlinearity of the feedback function can thus be performed by relatively arbitrary designs of the feedback function F. For this, it will suffice in principle to only multiply the output signals of two memory cells Dᵢ and Dᵢ₊₁, wherein a squared shift register would be the result of this. Of course, more than two memory cell outputs can be multiplied by one another or be subjected to some non-linear function. In principle, a feedback with only one output signal of a single memory could, however, also be performed by for example only feeding the output signal of the memory cell D₀, feeding it to the function F(x₀) and feeding the output signal of this function, for example, on the input side into the memory cell Dₙ₋₁. Such a non-linear function with only one value would, for example, be an inversion, i.e. a logic NOT function. The non-linear function could, however, also be any other function, such as, for example, a non-linear association function or a cryptographic function.

Depending on the circumstances, the inventive method for producing pseudorandom numbers can be implemented in either hardware or software. The implementation can take place on a digital storage medium, such as, for example, a floppy disc or a CD with control signals which can be read out electronically and which can cooperate with a programmable computer system such that the corresponding method will be executed. In general, the invention also includes a computer program product having a program code stored on a machine-readable carrier for performing the inventive method when the computer program product runs on a computer. Put differently, the invention can thus be realized as a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A pseudorandom number generator comprising:
a first elemental shift register having a non-linear feedback feature and a first elemental shift register output;
a second elemental shift register having a second elemental shift register output; and
combiner for combining the first elemental shift register output and the second elemental shift register output to obtain a combined signal including a pseudorandom number at an output.

2. The pseudorandom number generator according to claim 1, wherein the combiner comprises a multiplier, an adder, a divider and/or a subtracter.

3. The pseudorandom number generator according to claim 1, further comprising a third elemental shift register having a third elemental shift register output,
wherein the combiner is formed to combine the first elemental shift register output, the second elemental shift register output and additionally the third elemental shift register output.

4. The pseudorandom number generator according to claim 3,
wherein the combiner is formed to multiply signals at the first elemental shift register output and the second elemental shift register output to obtain a multiplication result, and to add the multiplication result to a signal at the third elemental shift register output to obtain the combined signal.

5. The pseudorandom number generator according to claim 1,
wherein the combiner is formed to only use an associated elemental shift register output of each elemental shift register once.

6. The pseudorandom number generator according to claim 1,
further comprising clock unit, wherein the clock unit is formed to clock the elemental shift registers and the combiner.

7. The pseudorandom number generator according to claim 1,
wherein an elemental shift register comprises:
feedforward unit; and
feedback unit coupled to the feedforward unit, wherein the feedback unit is formed to implement a non-linear function using one or several states in the feedforward unit so that at an output signal from the feedback unit is in a non-linear context to an input signal in the feedback unit.

8. The pseudorandom number generator according to claim 1, wherein each elemental shift register comprises:
a plurality of memory cells connected in series,
wherein the elemental shift register output is coupled to an output of a memory cell, and
a feedback unit having a feedback input and a feedback output, wherein the feedback unit is connected to an output of a memory cell,
wherein the feedback unit is formed to combine signals at outputs of at least two memory cells with each other in a non-linear way.

9. The pseudorandom number generator according to claim 1,
wherein each elemental shift register includes a number of memory cells, and
wherein the number of memory cells of the elemental shift registers is selected such that they do not have a common divisor among one another.

10. The pseudorandom number generator according to claim 1,
wherein each elemental shift register is formed such that it produces a sequence having a periodicity which is the maximal periodicity or at least 75% of the maximal periodicity.

11. The pseudorandom number generator according to claim 10, wherein the elemental shift register has a number N of memory cells, and wherein the sequence has a period length of 2^{N}−1.

12. The pseudorandom number generator according to claim 1, further comprising a third elemental shift register and a fourth elemental shift register, and
wherein the combiner is formed to combine signals at the first elemental shift register output and the second elemental shift register output by means of an AND gate, and to combine signals at an output of the third elemental shift register, at an output of the fourth elemental shift register and at an output of the AND gate by an XOR gate.

13. The pseudorandom number generator according to claim 1, further comprising a third elemental shift register, a fourth elemental shift register and a fifth elemental shift register, and
wherein the combiner is formed to combine signals at the outputs of the first elemental shift register, the second elemental shift register and the fifth elemental shift register by means of an AND gate, and to combine signals at an output of the third elemental shift register, the fourth elemental shift register and the AND gate by means of an XOR gate.

14. The pseudorandom number generator according to claim 1, further including a third elemental shift register, a fourth elemental shift register, a fifth elemental shift register, a sixth elemental shift register, a seventh elemental shift register, an eight elemental shift register, a ninth elemental shift register and a tenth elemental shift register, and
wherein the combiner is formed to combine signals at outputs of the first elemental shift register, the second elemental shift register and the fifth elemental shift register by means of a first AND gate,
to combine signals at outputs of the sixth elemental shift register and the seventh elemental shift register by means of a second AND gate,
to combine signals at outputs of the eight elemental shift register and the ninth elemental shift register by means of a third AND gate, and
to combine signals at outputs of the third elemental shift register, the fourth elemental shift register, the tenth elemental shift register and the first AND gate, the second AND gate and the third AND gate by means of an XOR gate.

15. The pseudorandom number generator according to claim 1, further including a third, fourth, fifth, sixth, seventh, eight, ninth, tenth and eleventh elemental shift register, and
wherein the combiner is formed to combine signals at outputs of the first, the second, the fifth, the ninth, the tenth and the eleventh elemental shift register by means of an AND gate, and
to combine signals at outputs of the third, fourth, sixth, seventh, eight elemental shift register and the AND gate by means of an XOR gate to obtain the combined signal.

16. The pseudorandom number generator according to claim 1,
wherein each elemental shift register is an elemental shift register having a non-linear feedback feature.

17. The pseudorandom number generator according to claim 1,
wherein the combiner is formed to include a gate selected from the group consisting of an AND gate, a NAND gate, an OR gate, a NOR gate, an XOR gate, and an XNOR gate.

18. A method for generating a sequence of pseudorandom numbers, comprising the following steps:
operating a first elemental shift register having a non-linear feedback feature and a first elemental shift register output;
operating a second elemental shift register having a second elemental shift register output; and
combining signals at the first elemental shift register output and the second elemental shift register output to obtain a combined signal representing a pseudorandom number of the sequence of pseudorandom numbers.

19. A computer program having a program code for performing a method when the computer program runs on a computer, wherein the method comprises the steps of: operating a first elemental shift register having a non-linear feedback feature and a first elemental shift register output; operating a second elemental shift register having a second elemental shift register output; and combining signals at the first elemental shift register output and the second elemental shift register output to obtain a combined signal representing a pseudorandom number of the sequence of pseudorandom numbers.
